(19) United States
(12) Patent Application Publication
(10) Pub. No.: US 2020/0211594 A1
(43) Pub. Date: Jul. 2, 2020

(54) ALUMINUM ALLOY SUBSTRATE FOR MAGNETIC RECORDING MEDIUM, SUBSTRATE FOR MAGNETIC RECORDING MEDIUM, MAGNETIC RECORDING MEDIUM, HARD DISK DRIVE

(71) Applicant: SHOWA DENKO K.K., Tokyo (JP)

(72) Inventors: Koji YUKIMATSU, Oyama-shi (JP); Hiroyuki MACHIDA, Oyama-shi (JP); Sho YOKOYAMA, Oyama-shi (JP)

(73) Assignee: SHOWA DENKO K.K., Tokyo (JP)

(21) Appl. No.: 16/727,476

(22) Filed: Dec. 26, 2019

(30) Foreign Application Priority Data
Dec. 28, 2018 (JP) 2018-247150

(51) Int. Cl. G11B 5/73

(52) U.S. Cl. CPC G11B 5/73919; G11B 5/7363

(57) ABSTRACT

What is provided is an aluminum alloy substrate for a magnetic recording medium which has high rigidity and an excellent plating properties. The aluminum alloy substrate for a magnetic recording medium has a constitution in which coarse grains whose average grain size is within a range that exceeds 2 μm and is less than or equal to 20 μm are dispersed, the average number of coarse grains per area of 0.042 mm² is 100 or more, and a surface roughness Ra is less than or equal to 0.2 μm.

### BACKGROUND OF THE INVENTION

### Field of the Invention

The present invention relates to an aluminum alloy substrate for a magnetic recording medium, a substrate for a magnetic recording medium, a magnetic recording medium, and a hard disk drive (HDD).

Priority is claimed on Japanese Patent Application No. 2018-247150, filed Dec. 28, 2018, the content of which is incorporated herein by reference.

### Description of Related Art

In recent years, a magnetic recording medium used in a hard disk drive has been remarkably improved in recording density. Especially, an increase in a surface recording density of the magnetic recording medium has been further intensified since magnetoresistive (MR) head or partial response maximum likelihood (PRML) technology was introduced.

Further, due to recent development of Internet networks or recent expansion of utilization of big data, a stored volume of data in a data center also continues to increase. Due to a space issue of the data center, the necessity for increasing a recording capacity per unit volume of the data center occurs. That is, to increase a recording capacity per one standardized hard disk drive, in addition to increasing a recording capacity per a magnetic recording medium, there have been attempts to increase the number of magnetic recording media stored in a drive case.

An aluminum alloy substrate and a glass substrate are mainly used as a substrate for a magnetic recording medium. Of these substrates, the aluminum alloy substrate has higher toughness and is more easily fabricated compared to the glass substrate, and thus is used for a magnetic recording medium whose outer diameter is relatively large. Since the thickness of the aluminum alloy substrate used for a magnetic recording medium of a 3.5-inch type hard disk drive is typically 1.27 mm, maximum five magnetic recording media can be stored in the drive case.

To increase the number of magnetic recording media stored in the drive case, an attempt is made to thin the substrate used for the magnetic recording medium.

However, in the case where the substrate is thinned, the aluminum alloy substrate has a problem in that fluttering is more easily caused than the glass substrate.

The fluttering is flapping of the magnetic recording medium caused when the magnetic recording medium is rotated at a high speed. If the fluttering is increased, it is difficult to stably read magnetic information of the hard disk drive.

For example, it is known that, to limit the fluttering in the glass substrate, a material having high specific elasticity (specific Young's modulus) is used as the substrate for a magnetic recording medium (e.g., see Japanese Unexamined Patent Application, First Publication No. 2015-26414).

Further, technology for filling the inside of the drive case of the 3.5-inch type hard disk drive with a helium gas and reducing the fluttering is known. Thus, the aluminum alloy substrate can be thinned, and an attempt is made to store six or more magnetic recording media in the drive case.

A substrate for a magnetic recording medium is generally fabricated by the following processes.

First, an aluminum alloy ingot is rolled to obtain an aluminum alloy sheet material having a thickness of about 2 mm or less, and the aluminum alloy sheet material is punched in a disk shape and obtains desired dimensions.

Next, chamfering of inner and outer diameters and turning of data surfaces are performed on the disk of the punched aluminum alloy sheet material. Afterward, in order to reduce surface roughness and waviness of the aluminum alloy sheet material, the aluminum alloy sheet material is ground by grindstone to obtain an aluminum alloy substrate. Next, for the purpose of application of surface hardness and slimitation of surface defects, surfaces of the aluminum alloy substrate are plated with a nickel alloy such as NiP. Next, polishing is performed on both surfaces (data surfaces) of the aluminum alloy substrate on which a nickel alloy plating film is formed.

Because the substrate for a magnetic recording medium is a mass-produced product and requires high cost performance, high machinability and inexpensiveness are required of an aluminum alloy.

Japanese Unexamined Patent Application, First Publication No. 2009-24265 disclose an aluminum alloy, which contains 0.3 to 6% by mass of Mg, 0.3 to 10% by mass of Si, 0.05 to 1% by mass of Zn, and 0.001 to 0.3% by mass of Sr, and a balance composed of Al and impurities.

PCT International Publication No. WO2016/068293 disclose an aluminum alloy substrate for a magnetic disk, which contains no less than 0.5% by mass and no more than 24.0% by mass of Si, and no less than 0.01% by mass and no more than 3.00% by mass of Fe, and a balance composed of Al and inevitable impurities.

Japanese Unexamined Patent Application, First Publication No. H06-145927 discloses a method for manufacturing an Al—Mg based alloy rolled sheet for a magnetic disk, which includes continuous casting an Al—Mg based alloy containing 2.0 to 6.0 wt % of Mg into a plate having a thickness of 4 to 10 mm, cold-rolling the cast plate at a high processing ratio of 50% or higher without performing uniform heat treatment, and then performing annealing at a temperature of 300 to 400° C. to make a rolled sheet whose surface layer portion has an average grain size of 15 μm or less. Here, the Al—Mg based alloy contains 2.0 to 6.0 wt % of Mg, and 0.01 to 0.1 wt % of one or both of Ti and B, and further contains one or both of 0.03 to 0.3 wt % of Cr and 0.03 to 0.3 wt % of Mn.

Japanese Unexamined Patent Application, First Publication No. 2017-120680 discloses, in order to provide a substrate for a magnetic recording medium having a high Young's modulus and excellent machinability, a technique in which, in the alloy structure of an aluminum alloy substrate including Mg in a range of 0.2% to 6% by mass, Si in a range of 3% to 17% by mass, Zn in a range of 0.05% to 2% by mass, and Sr in a range of 0.001% to 1% by mass, the average particle diameter of Si particles is set to 2 μm or less.

### SUMMARY OF THE INVENTION

In the magnetic recording medium used for a hard disk drive, it is desirable to suppress fluttering, that is, for a width of displacement (non-repeatable run-out (NRRO)) caused by fluttering to be small. Further, it is desirable to form each layer of the magnetic recording medium such as a magnetic layer with a uniform thickness and high flatness. Accordingly, it is desirable for the aluminum alloy substrate serving as the substrate of the magnetic recording medium to be able to form a nickel alloy plating film having high rigidity and flatness, that is, to have excellent plating properties.

However, according to the review of the inventors, if any of the aluminum alloys set forth in Japanese Unexamined Patent Application, First Publication No. 2009-24265, PCT International Publication No. WO2016/068293, Japanese Unexamined Patent Application, First Publication No. H06-145927 and Japanese Unexamined Patent Application, First Publication No. 2017-120680 is used, when six or more thin substrates can be stored in the drive case of the 3.5-inch type hard disk drive, it may be difficult to improve both rigidity and plating properties.

The present invention was made in view of the above circumstances, and an object of the present invention is to provide an aluminum alloy substrate for a magnetic recording medium having high rigidity and an excellent plating properties. Further, an object of the present invention is to provide a substrate for a magnetic recording medium using the aluminum alloy substrate for a magnetic recording medium, a magnetic recording medium, and a hard disk drive including the magnetic recording medium.

The inventors of the present invention conducted intensive research and found that coarse grains whose average grain size is within a range that exceeds 2 μm and is less than or equal to 20 μm are dispersed in an aluminum alloy such that the average number of coarse grains per area of 0.042 mm² is 100 or more, and surface roughness Ra is less than or equal to 0.2 μm, so that both rigidity and a plating properties can be improved, and completed the present invention.

In order to solve the above problems, the present invention provides the following means.

(1) An aluminum alloy substrate for a magnetic recording medium according to an aspect of the present invention is characterized in that: coarse grains whose average grain size is within a range that exceeds 2 μm and is less than or equal to 20 μm are dispersed; the average number of coarse grains per area of 0.042 mm² is 100 or more; and a surface roughness Ra is less than or equal to 0.2 μm,

(2) A substrate for a magnetic recording medium according to another aspect of the present invention includes: an aluminum alloy substrate; and a nickel alloy plating film formed on at least one surface of the aluminum alloy substrate. The aluminum alloy substrate is the aluminum alloy substrate for a magnetic recording medium defined in (1) above, and a thickness of the nickel alloy plating film is within a range of 4 μm or more and 15 μm or less.

(3) A magnetic recording medium according to yet another aspect of the present invention includes: a substrate for a magnetic recording medium; and a magnetic layer formed on a surface of the substrate for a magnetic recording medium. The substrate for a magnetic recording medium is the substrate for a magnetic recording medium defined in (2) above, and the magnetic layer is formed on the surface of the substrate for a magnetic recording medium on which the nickel alloy plating film is formed.

(4) A hard disk drive according to still yet another aspect of the present invention includes a magnetic recording medium. The magnetic recording medium is the magnetic recording medium defined in (3) above.

According to the present invention, an aluminum alloy substrate for a magnetic recording medium that has high rigidity and excellent plating properties can be provided. Further, according to the present invention, a substrate for a magnetic recording medium using the aluminum alloy substrate for a magnetic recording medium, a magnetic recording medium, and a hard disk drive including the magnetic recording medium can be provided.

### BRIEF DESCRIPTION OF THE DRAWINGS

FIG. 1 is a schematic sectional view showing an example of an aluminum alloy substrate for a magnetic recording medium according to the present embodiment.

FIG. 2 is a schematic sectional view showing an example of a substrate for a magnetic recording medium according to the present embodiment.

FIG. 3 is a perspective view showing an example of a polishing machine that can be used in fabricating the substrate for a magnetic recording medium according to the present embodiment.

FIG. 4 is a schematic sectional view showing an example of the magnetic recording medium according to the present embodiment.

FIG. 5 is a perspective view showing an example of a hard disk drive according to the present embodiment.

### DETAILED DESCRIPTION OF THE INVENTION

Hereinafter, an aluminum alloy substrate for a magnetic recording medium, a substrate for a magnetic recording medium, a magnetic recording medium, and a hard disk drive according to embodiments of the present invention will be described in detail with proper reference to the drawings. Note that the drawings used in the following description may show characteristic portions in an enlarged scale for convenience in order to facilitate understanding of features of the present invention and, for example, dimensional ratios of the components may be different from reality.

[Aluminum Alloy Substrate for a Magnetic Recording Medium]

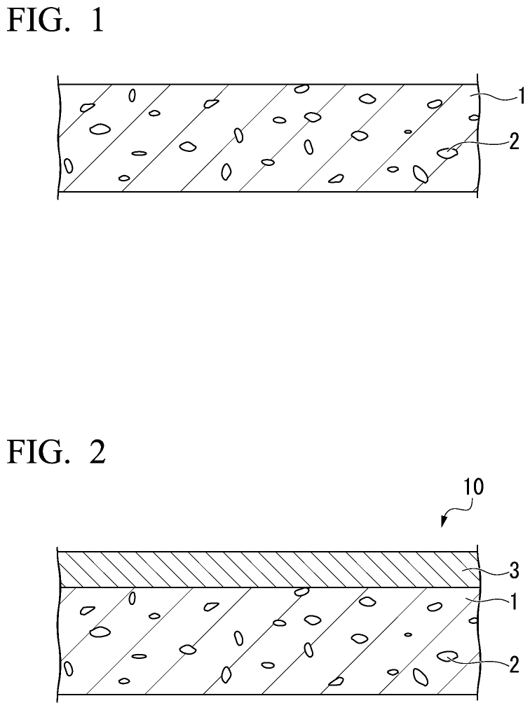

FIG. 1 is a schematic sectional view showing an example of an aluminum alloy substrate for a magnetic recording medium according to the present embodiment.

As shown in FIG. 1, coarse grains 2 are dispersed in an aluminum alloy substrate 1 for a magnetic recording medium. The coarse grains 2 function to improve rigidity of the aluminum alloy substrate 1 for a magnetic recording medium.

An average grain size of the coarse grains 2 is within a range that exceeds 2 μm and is less than or equal to 20 μm. If the average grain size of the coarse grains 2 is too small, an effect of improving the rigidity of the aluminum alloy substrate 1 for a magnetic recording medium may be reduced. On the other hand, if the average grain size of the coarse grains 2 is too large, hardness of the aluminum alloy substrate 1 for a magnetic recording medium may be too high, and the aluminum alloy substrate 1 may be too brittle. Especially, the average grain size of the coarse grains 2 is preferably within a range of 5 μm or more and 15 μm or less. Shapes of the coarse grains 2 are not particularly limited, and may be, for example, a spherical shape, a plate shape, a needle shape, or a spheroidal shape.

The amount of the coarse grains 2 is 100 or more as the average number of coarse grains per area of 0.042 mm². If the amount of the coarse grains 2 is too low, an effect of improving the rigidity of the aluminum alloy substrate 1 for a magnetic recording medium may be reduced. However, if the amount of the coarse grains 2 is too high, hardness of the aluminum alloy substrate 1 for a magnetic recording medium may be too high, and the aluminum alloy substrate 1 may be too brittle. For this reason, the average number of coarse grains 2 per area of 0.042 mm² is preferably 2000 or less. The average number of coarse grains 2 per area of 0.042 mm² is particularly preferably within a range of 300 or more and 1000 or less.

A surface roughness Ra of the aluminum alloy substrate 1 for a magnetic recording medium is set to 0.2 μm or less. The surface roughness Ra is as low as 0.2 μm or less, and thereby plating properties of the aluminum alloy substrate 1 for a magnetic recording medium is improved.

The aluminum alloy substrate 1 for a magnetic recording medium has a Young's modulus E of 74 GPa or more and a density p of 2.75 g/cm³ or less, and a ratio E/p between the Young's modulus E represented in units of GPa and the density p represented in units of g/cm³ is preferably set to 27 or more.

The Young's modulus is an index that represents ease of deformation. If the Young's modulus E of the aluminum alloy substrate 1 for a magnetic recording medium becomes higher, there tends to be less NRRO. For this reason, the Young's modulus E of the aluminum alloy substrate 1 for a magnetic recording medium is preferably 74 GPa or more, and particularly preferably within a range of 74 GPa or more and 100 GPa or less.

If the density p of the aluminum alloy substrate 1 for a magnetic recording medium is reduced, the NRRO is apt to be reduced. For this reason, although the density p of the aluminum alloy substrate 1 for a magnetic recording medium is changed by a composition of the aluminum alloy substrate, it is preferably 2.75 g/cm³ or less, and particularly preferably within a range of 2.60 g/cm³ or more and 2.75 g/cm³ or less.

If the ratio E/p between the Young's modulus E (in units of GPa) and the density ρ (in units of g/cm³) becomes higher, fluttering is not easily caused, and there tends to be less NRRO. For this reason, the ratio E/ρ of the aluminum alloy substrate 1 for a magnetic recording medium is preferably 27 or more, and particularly preferably within a range of 28 or more and 39 or less.

Even if the aluminum alloy substrate 1 for a magnetic recording medium of the present embodiment is a thin substrate of which six or more can be stored in a drive case of a 3.5-inch type hard disk drive, fluttering is not easily caused, and there is little NRRO. A thickness of the aluminum alloy substrate 1 for a magnetic recording medium is preferably within a range of 0.48 mm or more and 0.64 mm or less.

[Method of Fabricating Aluminum Alloy Substrate for Magnetic Recording Medium]

The aluminum alloy substrate 1 for a magnetic recording medium can be fabricated, for instance, by a method that includes a casting process of making an aluminum alloy ingot, a rolling process of rolling the aluminum alloy ingot in a sheet shape and obtaining an aluminum alloy sheet material, and a processing process of molding the aluminum alloy sheet material into the aluminum alloy substrate 1 for a magnetic recording medium.

(Casting Process)

In the casting process, an aluminum alloy is cast to make an aluminum alloy ingot.

For example, a known method used as an aluminum alloy casting method such as a direct chill casting method (a DC casting method) or a continuous casting (CC) method may be used as the method for casting the aluminum alloy. The DC casting method is a method of casting an aluminum alloy ingot by pouring a molten metal of an aluminum alloy into a mold and then directly bringing the mold into contact with cooling water. The CC method is a method of continuously pouring a molten metal of an aluminum alloy into a mold and rapidly cooling the molten metal in the mold.

The molten metal of the aluminum alloy preferably contains a precipitation hardening type element that is precipitated and hardened in a parent phase. Examples of the precipitation hardening type element may include silicon and iron. The amount of the precipitation hardening type element in the molten metal of the aluminum alloy differs according to a type of the precipitation hardening type element but, for example, is within a range of 8% by mass or more and 34% by mass or less in the case of the silicon, and is within a range of 0.5% by mass or more and 8% by mass or less in the case of the iron.

In the casting process, the molten metal of the aluminum alloy is cooled such that coarse grains are generated in the aluminum alloy ingot. Cooling conditions cannot be uniformly determined because they differ according to conditions such as a casting method, a type of the precipitation hardening type element, and so on. However, usually when a cooling time is prolonged, coarse grains are easily generated.

(Rolling Process)

In the rolling process, the aluminum alloy ingot obtained in the above casting process is rolled in a sheet shape, and thereby an aluminum alloy sheet material is obtained. A rolling method is not particularly limited, and either of a hot rolling method and a cold rolling method may be used as the rolling method. According to rolling conditions, grain sizes of the coarse grains of the aluminum alloy sheet material can be adjusted. The rolling conditions are not particularly limited, and typical conditions under which an aluminum alloy ingot is rolled may be used as the rolling conditions.

(Processing Process)

In the processing process, first, the aluminum alloy sheet material obtained in the above rolling process is punched in a disk shape, and thereby an aluminum alloy disk is obtained. Next, the aluminum alloy disk is heated at a temperature of 300° C. or higher and 500° C. or lower within a range of 0.5 hr or more and 5 hr or less, and is annealed. Strain in the aluminum alloy disk is relieved by performing the annealing, and rigidity of the obtained aluminum alloy substrate can be adjusted within an appropriate range. Next, surfaces and an end face of the annealed aluminum alloy disk are cut using a cutting tool. The annealing may be performed after the cutting.

In the present embodiment, the coarse grains are dispersed in the aluminum alloy disk. For this reason, in the cutting process, it is necessary to take care that surface roughness of the aluminum alloy disk does not increase.

The cutting tool used for the cutting is preferably a tool having a cutting edge in which nano-polycrystalline diamond is used. The cutting is preferably performed in the presence of a water-soluble cutting oil. The water-soluble cutting oil is preferably an emulsion type in which fluid particles whose particle diameters are within a range of 0.1 to 10 μm are dispersed. Cutting is performed in the presence of the water-soluble cutting oil in which the fine fluid particles are dispersed using the cutting tool having a cutting edge in which nano-polycrystalline diamond is used, and thereby the aluminum alloy substrate 1 for a magnetic recording medium having low surface roughness Ra can be obtained.

According to the aluminum alloy substrate 1 for a magnetic recording medium of the present embodiment configured as described above, since the coarse grains whose average grain size is within a range that exceeds 2 μm and is less than or equal to 20 μm are dispersed such that the average number of coarse grains per area of 0.042 mm² is 100 or more, rigidity is increased. For this reason, even if the aluminum alloy substrate 1 for a magnetic recording medium of the present embodiment is, for instance, a thin substrate whose thickness is set to be within a range of 0.48 mm or more and 0.64 mm or less and of which six or more can be stored in the drive case of the 3.5-inch type hard disk drive, the fluttering is not easily caused, and there is little NRRO. Further, since the surface roughness Ra of the aluminum alloy substrate 1 for a magnetic recording medium of the present embodiment is set to 0.2 μm or less, the aluminum alloy substrate 1 also has excellent plating properties.

[Substrate for Magnetic Recording Medium]

FIG. 2 is a schematic sectional view showing an example of a substrate for a magnetic recording medium according to the present embodiment.

As shown in FIG. 2, a substrate 10 for a magnetic recording medium has an aluminum alloy substrate 1 for a magnetic recording medium, and a nickel alloy plating film 3 formed on at least one surface of the aluminum alloy substrate for a magnetic recording medium. The aluminum alloy substrate 1 for a magnetic recording medium is the aluminum alloy substrate for a magnetic recording medium of the aforementioned present embodiment.

The nickel alloy plating film 3 has a function of enhancing hardness of the surfaces of the substrate 10 for a magnetic recording medium to improve strength of the substrate 10 for a magnetic recording medium, and a function of planarizing the surfaces of the substrate 10 for a magnetic recording medium to limit surface defects. If the thickness of the nickel alloy plating film 3 is excessively thinned, there is a risk of the above functions not being easily obtained. On the other hand, if the thickness of the nickel alloy plating film 3 becomes too thick, the mass of the substrate 10 for a magnetic recording medium increases, and there is a risk of fluttering being easily caused and NRRO increasing.

For this reason, in the present embodiment, the thickness of the nickel alloy plating film 3 is set to be within a range of 4 μm or more and 15 μm or less.

The nickel alloy plating film 3 is preferably a nickel-phosphorus (NiP) alloy plating film or a nickel-tungsten-phosphorus (NiWP) alloy plating film. The NiP alloy preferably contains P within a range of 10% by mass or more and 15% by mass or less, and a balance of Ni and inevitable impurities. The NiWP alloy preferably contains W within a range of 15% by mass or more and 22% by mass or less, P within a range of 3% by mass or more and 10% by mass or less, and a balance of Ni and inevitable impurities. The nickel alloy plating film 3 is formed of a NiP alloy or a NiWP alloy, and thereby hardness and flatness of the surface of the substrate 10 for a magnetic recording medium can be reliably improved.

<Method for Fabricating Substrate for Magnetic Recording Medium>

The substrate 10 for a magnetic recording medium of the present embodiment may be fabricated, for instance, by a method that includes a plating process of forming the nickel alloy plating film 3 on the aluminum alloy substrate 11 using a plating method, and a polishing working process of performing a polishing process on a surface of the aluminum alloy substrate with the nickel alloy plating film.

(Plating Process)

In the plating process, an electroless plating method is preferably used as the method for forming the nickel alloy plating film 3 on the aluminum alloy substrate 11. A plating film formed of a nickel alloy may be formed using a method used so far. For example, a plating solution that contains nickel sulfate as a nickel source and hypophosphite as a phosphorus source may be used as a plating solution for forming a NiP alloy plating film. A plating solution in which tungstate is added to the plating solution for forming the NiP alloy plating film may be used as a plating solution for forming a NiWP alloy plating film. For example, sodium tungstate, potassium tungstate, ammonium tungstate, or the like may be used as the tungstate.

The thickness of the nickel alloy plating film can be adjusted by an immersion time in a plating solution and a temperature of the plating solution. Plating conditions are not particularly limited, but preferably set pH of the plating solution to 5.0 to 8.6, a temperature of the plating solution to 70° C. to 100° C., and preferably 85° C. to 95° C., and an immersion time in the plating solution to 90 to 150 minutes.

An aluminum alloy substrate with the obtained nickel alloy plating film is preferably subjected to heat treatment. Thus, hardness of the nickel alloy plating film can be further increased, and Young's modulus of the substrate for a magnetic recording medium can be further increased. The temperature of the heat treatment is preferably set to 200° C. or higher.

(Polishing Working Process)

In the polishing working process, a surface of the aluminum alloy substrate with the nickel alloy plating film obtained in the plating process is polished. The polishing working process preferably adopts a multistage polishing method having a polishing process of two or more stages using a plurality of independent polishing machines from the viewpoint of both improvement of surface quality that is smooth and has little damage and improvement of productivity. For example, a rough polishing process of polishing the aluminum alloy substrate using a first polishing machine while supplying a polishing solution containing alumina abrasive grains, and a finish polishing process of cleaning the polished aluminum alloy substrate and then polishing the cleaned aluminum alloy substrate using a second polishing machine while supplying a polishing solution containing colloidal slica abrasive grains are performed.

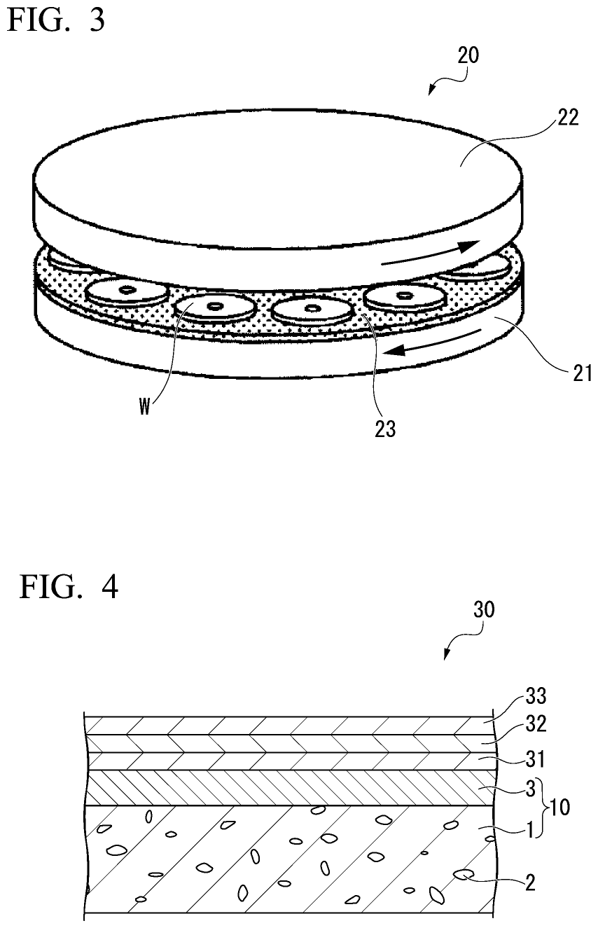

FIG. 3 is a perspective view showing an example of polishing machines that can be used in a polishing working process.

As shown in FIG. 3, each of the first and second polishing machines 20 includes a pair of upper and lower surface plates 21 and 22, and polishes both surfaces of a plurality of substrates W by means of polishing pads 23 provided on the surface plates 21 and 22 while sandwiching the substrates W between the surface plates 21 and 22 that are rotated in direction opposite to each other.

According to the substrate 10 for a magnetic recording medium of the present embodiment configured as described above, since the aluminum alloy substrate 1 for a magnetic recording medium of the aforementioned present embodiment is used as the aluminum substrate, rigidity is high. For this reason, even if the thickness of the substrate 10 for a magnetic recording medium of the present embodiment is set to be within a range of 0.48 mm or more and 0.64 mm or less, fluttering is not easily caused, and there is little NRRO. Further, according to the substrate 10 for a magnetic recording medium of the present embodiment, the nickel alloy plating film 3 has little defects and high flatness. For this reason, each layer such as the magnetic layer constituting the magnetic recording medium can be formed on the surface of the nickel alloy plating film 3 with a uniform thickness and high flatness.

[Magnetic Recording Medium]

FIG. 4 is a schematic sectional view showing an example of the magnetic recording medium according to the present embodiment.

As shown in FIG. 4, the magnetic recording medium 30 includes the aforementioned substrate 10 for a magnetic recording medium, and a magnetic layer 31 formed on a surface of the nickel alloy plating film 3 of the substrate 10 for a magnetic recording medium. A protective layer 32 and a lubricant layer 33 are further laminated on a surface of the magnetic layer 31 in this order.

The magnetic layer 31 is formed of a magnetic film in which an axis of easy magnetization is directed in a direction perpendicular to a substrate surface. The magnetic layer 31 is a layer that contains Co and Pt, and may be a layer that contains an oxide, Cr, B, Cu, Ta, Zr, or the like to further improve an SNR characteristic. The oxide contained in the magnetic layer 31 includes SiO₂, SiO, Cr₂O₃, CoO, Ta₂O₃, TiO₂, or the like. The magnetic layer 31 may be a layer formed of one layer, or a layer formed of a plurality of layers formed of materials having different compositions.

The thickness of the magnetic layer 31 is preferably set to 5 to 25 nm.

The protective layer 32 is a layer that protects the magnetic layer 31. For example, carbon nitride may be used as a material of the protective layer 32. The protective layer 32 may be a layer formed of one layer, or a layer formed of a plurality of layers.

The thickness of the protective layer 32 is preferably within a range between 1 nm or more and 10 nm or less.

The lubricant layer 33 is a layer that prevents contamination of the magnetic recording medium 30, and that reduces a frictional force of a magnetic head of a magnetic recording/reproducing device sliding on the magnetic recording medium 30 and improves durability of the magnetic recording medium 30. For example, a perfluoropolyether-based lubricant or an aliphatic hydrocarbon-based lubricant may be used as a material of the lubricant layer 33.

The thickness of the lubricant layer 33 is preferably within a range between 0.5 nm or more and 2 nm or less.

The layer constitution of the magnetic recording medium 30 according to the present embodiment is not particularly limited, and a well-known laminated structure may be applied to the layer constitution. For example, in the magnetic recording medium 30, an adhesion layer (not shown), a soft magnetic underlayer (not shown), a seed layer (not shown), and an orientation control layer (not shown) may be laminated between the substrate 10 for a magnetic recording medium and the magnetic layer 31 in this order.

Each of the magnetic layer 31, the protective layer 32, and the lubricant layer 33 that constitute the magnetic recording medium 30 according to the present embodiment has a nanometer-order thickness, and is extremely thin compared to the thicknsess of the substrate 10 for a magnetic recording medium. Accordingly, the thickness of the magnetic recording medium 30 is substantially the same as that of the substrate 10 for a magnetic recording medium.

According to the magnetic recording medium 30 of the present embodiment configured as described above, since the magnetic recording medium 30 uses the aforementioned substrate 10 for a magnetic recording medium, rigidity is high. Even if the thickness of the magnetic recording medium 30 is set to be within a range of 0.48 mm or more and 0.64 mm or less, fluttering is not easily caused, and there is little NRRO. Further, according to the magnetic recording medium 30 of the present embodiment, each layer such as the magnetic layer 31 or the protective layer 32 can be formed with a uniform thickness and high flatness.

[Hard Disk Drive]

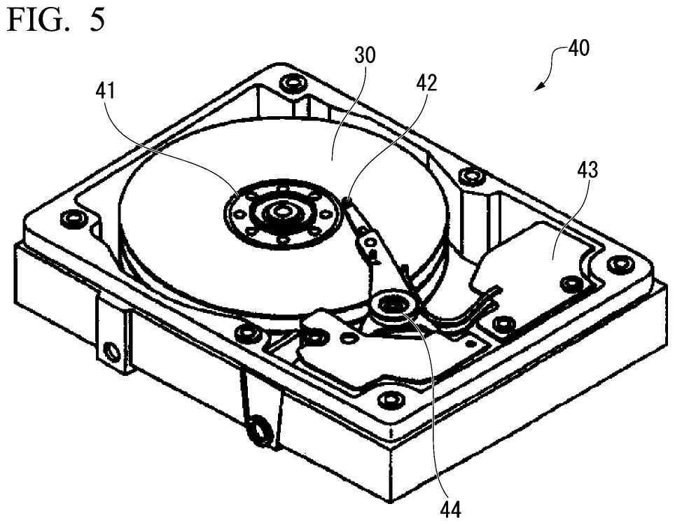

FIG. 5 is a perspective view showing an example of a hard disk drive according to the present embodiment.

As shown in FIG. 5, the hard disk drive 40 includes the aforementioned magnetic recording medium 30, a medium driving unit 41 that drives the magnetic recording medium 30 in a recording direction, a magnetic head 42 that is made up of a recording unit and a reproducing unit, a head moving unit 43 that moves the magnetic head 42 relative to the magnetic recording medium 30, and a recording/reproducing signal processing unit 44 that processes a recording/reproducing signal from the magnetic head 42. The hard disk drive 40 is a 3.5-inch type hard disk drive.

According to the hard disk drive 40 according to the present embodiment, since the thickness of the magnetic recording medium 30 can be made as thin as a range of 0.48 mm or more and 0.64 mm or less, the number of the magnetic recording mediums 30 stored in the drive case can be increased, and thus a recording capacity can be increased. Further, the magnetic recording medium 30 is configured such that the fluttering is not easily caused and NRRO is reduced. For this reason, to reduce the fluttering of the magnetic recording medium 30, a low molecular weight gas such as helium need not be particularly enclosed in the hard disk drive case.

### EXAMPLES

Hereinafter, effects of the present invention are made more obvious by examples. The present invention is not limited to the following examples, and can be carried out through appropriate modification without departing from the subject matter of the present invention.

### Examples 1 to 4 and Comparative Examples 1 to 5

[Aluminum Alloy Sheet Material]

A pure Al ingot, Si, Fe, Mn, Cu, Mg, Zn, Sr, Zr, Ti, Ni, and Cr were prepared as Al raw materials. With regard to each raw materials of the pure Al ingot, Si, Fe, Mn, Cu, Mg, Zn, Sr, Zr, Ti, Ni, and Cr, each raw materials whose purity was higher than or equal to 99.9% by mass were prepared.

The raw materials of the prepared elements were weighed such that a composition after casting was a composition shown in Table 1 below, and were melted in air at 820° C., and alloys 1 to 3 were made. The obtained alloys 1 to 3 were made into aluminum alloy ingots using a direct chill casting method (a DC casting method). Next, the obtained aluminum alloy ingots were held and homogenized at 460° C. for 2 hours. Afterward, the homogenized aluminum alloy ingots were rolled into sheet materials having a thickness of 0.50 mm. In Examples 1 to 4 and Comparative Examples 1 to 5, in order to change an average number and an average grain size of coarse grains of the aluminum alloy sheet material, a cooling speed in the event of casting and a temperature in the event of rolling were appropriately changed.

Each of the obtained aluminum alloy sheet materials was punched in a disk shape that had a hole whose inner diameter was 24 mm in the center thereof and had a diameter of 96 mm, and was annealed at 380° C. for 1 hour. Afterward, as shown in Table 2 below, surfaces and an end face of the aluminum alloy disk were cut by an A or B method below, thereby obtaining an aluminum alloy substrate having a diameter of 95 mm and a thickness of 0.49 mm.

In the A method, a cutting tool having nano-polycrystalline diamond on the cutting edge was used as the cutting tool, and an emulsion type cutting oil in which fluid particles whose particle diameters were within a range of 0.1 μm to 10 μm were dispersed was used as the cutting oil.

In the B method, a cutting tool made of sinterable diamond was used as the cutting tool, and a water-insoluble cutting oil was used as the cutting oil.

[Evaluation of Aluminum Alloy Substrates]

With regard to the obtained aluminum alloy substrates, the following items were evaluated. The evaluated results are shown in Table 1.

(Average Number (Piece/0.042 mm²) and Average Grain Size of Coarse Grains)

An average grain size of coarse grains and the number of coarse grains per area of 0.042 mm² were measured using a scanning electron microscope (SEM). A measurement range of a square, one side of which was 0.205 mm (0.042 mm²), was determined on a surface of the aluminum alloy substrate, and this measurement range was magnified 500 times using the SEM. Thereby, a number and grain sizes of the coarse grains were measured using image analysis software (WinROOF (Ver 6.5)). The number and the grain sizes of the coarse grains were measured in four places, and averages thereof were set as an average number and an average grain size of the coarse grains.

(Young's Modulus E)

A Young's modulus E was measured at room temperature on the basis of the method regulated by JIS Z 2280-1993 (Test method for Young's modulus of metallic materials at elevated temperature). The aluminum alloy substrate was cut out in a strip shape having a length of 50 mm, a width of 10 mm, and a thickness of 0.49 mm, and the Young's modulus was measured using this as a test piece.

(Density ρ)

A density ρ was measured by the Archimedes method.

(Ratio E/ρ)

The ratio between the Young's modulus E (in units of GPa) and the density ρ (in units of g/cm³) that were measured as described above was calculated.

(Surface Roughness Ra)

Surface roughness Ra was measured using a stylus type surface roughness gauge (Surftest and available from Mitutoyo Corportion).

[Substrate for Magnetic Recording Medium]

Aluminum alloy substrates made in Examples 1 to 4 and Comparative Examples 1 to 5 were immersed in a NiP alloy plating solution, and a Ni₈₈P₁₂ (a amount of P was 12% by mass, and a balance was Ni) film as a NiP alloy plating film was formed on surfaces of the aluminum alloy substrates using an electroless plating method.

The NiP alloy plating solution whose components were adjusted in amount by containing nickel sulfate (a nickel source) and sodium hypophosphite (a phosphorus source) and appropriately adding lead acetate, sodium citrate, and sodium borate was used such that the NiP alloy plating film having the above composition was obtained. The NiP alloy plating solution during the formation of the NiP alloy plating film was adjusted to pH 6 and a solution temperature of 90° C. In Examples 1 to 4 and Comparative Examples 1 to 5, in order to change a thickness of the NiP alloy plating film, an immersion time of the aluminum alloy substrate in the NiP alloy plating solution was appropriately changed.

Next, the aluminum alloy substrate on which the NiP alloy plating film was formed was heated at 250° C. for 15 minutes, thereby obtaining an aluminum alloy substrate with a NiP alloy plating film.

Next, a polishing process was performed on a surface of the aluminum alloy substrate with a NiP alloy plating film using a 3-stage lapping machine having a pair of upper and lower surface plates as a polishing machine, thereby making a substrate for a magnetic recording medium. In this case, a suede type (available from Filwel Co., Ltd.) was used as a polishing pad. Alumina abrasive grains having D50 of 0.5 μm were used for first stage polishing, colloidal silica abrasive grains having D50 of 30 nm were used for second stage polishing, and colloidal silica abrasive grains having D50 of 10 nm were used for third stage polishing. Further, a polishing time for each stage was set to 5 minutes. The obtained substrate for a magnetic recording medium was sized such that the diameter was 95 mm, the inner diameter of the central hole was 25 mm, and the thickness was 0.49 mm.

[Evaluation of Substrates for Magnetic Recording Medium]

With regard to the obtained substrates for a magnetic recording medium, the following items were evaluated. The evaluated results are shown in Table 2 below.

(Thicknesses of NiP Alloy Plating Films)

Thicknesses of the NiP alloy plating films were measured using X-ray fluorescence analysis (XRF).

(Fluttering Characteristic)

The fluttering characteristic was evaluated by measuring NRRO. A width of displacement caused by fluttering generated on an outermost circumferential surface of the substrate for a magnetic recording medium by rotating the substrate for a magnetic recording medium at 10000 rpm for 1 minute was measured using a He—Ne laser displacement gauge, and a maximum value of the obtained width of displacement was used as NRRO.

The fluttering characteristic having NRRO of 3.4 or less was evaluated as “∘,” and the fluttering characteristic having NRRO exceeding 3.4 was evaluated as “x.”

(Plating Defect)

It was evaluated by an automated optical inspection machine using a laser whether or not a plating defect was present. A case where one or more plating defects were detected on the surface was evaluated as “x,” and a case where no plating defects were detected was evaluated as “∘.”

TABLE 1

| | | | | | | | | | | | | | Young's | | |
|---|---|---|---|---|---|---|---|---|---|---|---|---|---|---|---|
| | | | | | | | | | | | | | modulus | | |
| | Composition (% by mass) | | | | | | | | | | | | E | Density ρ | Ratio |
| | Si | Fe | Mn | Cu | Mg | Zn | Sr | Zr | Ti | Ni | Cr | Al | (GPa) | (g/cm³) | E/ρ |
| Alloy 1 | 10.9 | 0.01 | 0.13 | 1.12 | 0.63 | 0.36 | 0.03 | 0.05 | 0.11 | 0.11 | 0.11 | Balance | 79.0 | 2.762 | 28.6 |
| Alloy 2 | 0.04 | 1.06 | 0.34 | 0.12 | 0.88 | 0.17 | 0.00 | 0.00 | 0.00 | 1.11 | 0.10 | Balance | 78.3 | 2.830 | 27.7 |
| Alloy 3 | 0.01 | 0.01 | 0.00 | 0.01 | 3.70 | 0.32 | 0.00 | 0.00 | 0.00 | 0.00 | 0.06 | Balance | 73.0 | 2.800 | 26.1 |

TABLE 2

| | | Substrate for magnetic recording medium | | | | | | | | | |
|---|---|---|---|---|---|---|---|---|---|---|---|
| | | Aluminum alloy substrate | | | | | | | Thickness | | |
| | | Average | Average | | | | | | of NiP | | |
| | | number of | grain size | Young's | | | | Surface | alloy | | |
| | | coarse grains | of coarse | modulus | Density | | | roughness | plating | | |
| | | (piece/0.042 | grains | E | ρ | Ratio | Cutting | Ra | film | Fluttering | Plating |
| | Alloy | mm²) | (μm) | (GPa) | (g/cm³) | E/ρ | method | (μm) | (μm) | characteristic | defect |
| Example 1 | Alloy 2 | 458 | 2.5 | 75.0 | 2.74 | 27.37 | A method | 0.007 | 5 | ∘ | ∘ |
| Example 2 | Alloy 2 | 500 | 10 | 75.0 | 2.74 | 27.37 | A method | 0.007 | 5 | ∘ | ∘ |
| Example 3 | Alloy 2 | 537 | 20 | 75.0 | 2.74 | 27.37 | A method | 0.007 | 7 | ∘ | ∘ |
| Example 4 | Alloy 1 | 515 | 10 | 76.0 | 2.67 | 28.46 | A method | 0.007 | 7 | ∘ | ∘ |
| Comparative | Alloy 3 | Undetected | — | 70.0 | 2.66 | 26.32 | B method | 0.007 | 9 | x | ∘ |
| Example 1 | | | | | | | | | | | |
| Comparative | Alloy 2 | 607 | 30 | 75.0 | 2.74 | 27.37 | A method | 0.008 | 17 | x | ∘ |
| Example 2 | | | | | | | | | | | |
| Comparative | Alloy 2 | 500 | 10 | 75.0 | 2.74 | 27.37 | A method | 0.007 | 3 | x | x |
| Example 3 | | | | | | | | | | | |
| Comparative | Alloy 2 | 537 | 20 | 75.0 | 2.74 | 27.37 | B method | 0.27 | 7 | ∘ | x |
| Example 4 | | | | | | | | | | | |
| Comparative | Alloy 2 | 480 | 50 | 75.0 | 2.74 | 27.37 | A method | 0.22 | 7 | ∘ | x |
| Example 5 | | | | | | | | | | | |

In the magnetic recording mediums using the aluminum alloy substrates of Examples 1 to 4 in which the average grain size and the avergage number of coarse grains and the surface roughness Ra were within the range of the present invention, the fluttering characteristic was good, the width of displacement caused by fluttering was narrow, and the plating defects were reduced.

On the other hand, the aluminum alloy substrate of Comparative Example 1 from which the coarse grains were not detected was low in the Young's modulus, and the magnetic recording medium using this aluminum alloy substrate was deteriorated in the fluttering characteristic. Further, magnetic recording medium of Comparative Example 2 in which the thickness of the NiP alloy plating film was thicker than the range of the present invention was deteriorated in the fluttering characteristic. This was thought to be because the thickness of the NiP alloy plating film was thick, and thereby the mass of the entire substrate for a magnetic recording medium was increased. Furthermore, in the magnetic recording medium of Comparative Example 3 in which the thickness of the NiP alloy plating film was thinner than the range of the present invention, the fluttering characteristic was deteriorated, and the plating defects were increased. This was thought to be because the thickness of the NiP alloy plating film was thin, and thereby the rigidity of the entire substrate for a magnetic recording medium was reduced, and the strength of the NiP alloy plating film was reduced, and thus defects occurred easily.

Furthermore, in the magnetic recording medium using the aluminum alloy substrate of Comparative Example 4 in which the surface roughness Ra was coarser than the range of the present invention, the plating defects were increased. The aluminum alloy substrate of Comparative Example 5 in which the average grain size of the coarse grains was larger than the range of the present invention was high in the Young's modulus, but was increased in the surface roughness, and the magnetic recording medium using this aluminum alloy substrate was increased in the plating defects.

### EXPLANATION OF REFERENCES

1 Aluminum alloy substrate for magnetic recording medium
2 Coarse grain
3 Nickel alloy plating film
10 Substrate for magnetic recording medium
20 Polishing machine
21, 22 Surface plate
23 Polishing pad
30 Magnetic recording medium
31 Magnetic layer
32 Protective layer
33 Lubricant layer
40 Hard disk drive
41 Medium driving unit
42 Magnetic head
43 Head moving unit
44 Recording/reproducing signal processing unit

What is claimed is:

1. An aluminum alloy substrate for a magnetic recording medium
wherein coarse grains whose average grain size is within a range that exceeds 2 μm and is less than or equal to 20 μm are dispersed,
the average number of coarse grains per area of 0.042 mm² is 100 or more, and a surface roughness Ra is less than or equal to 0.2 μm.

2. A substrate for a magnetic recording medium comprising:
an aluminum alloy substrate; and
a nickel alloy plating film formed on at least one surface of the aluminum alloy substrate,
wherein the aluminum alloy substrate is the aluminum alloy substrate for a magnetic recording medium defined in claim 1, and
a thickness of the nickel alloy plating film is within a range of 4 μm or more and 15 μm or less.

3. A magnetic recording medium comprising:
a substrate for a magnetic recording medium; and
a magnetic layer formed on a surface of the substrate for a magnetic recording medium,
wherein the substrate for a magnetic recording medium is the substrate for a magnetic recording medium defined in claim 2, and
the magnetic layer is formed on the surface of the substrate for a magnetic recording medium on which the nickel alloy plating film is formed.

4. A hard disk drive comprising a magnetic recording medium,
wherein the magnetic recording medium is the magnetic recording medium defined in claim 3.
